(19) United States
(12) Patent Application Publication
(10) Pub. No.: US 2013/0337254 A1
(43) Pub. Date: Dec. 19, 2013

(54) POLYESTER MOLDED BODY AND METHOD FOR PRODUCING THE SAME

(71) Applicant: CANON KABUSHIKI KAISHA, Tokyo (JP)

(72) Inventors: Yoshinobu Okumura, Machida-shi (JP); Yuichi Hashimoto, Tokyo (JP); Masaki Sunaga, Atsugi-shi (JP)

(21) Appl. No.: 13/916,394

(22) Filed: Jun. 12, 2013

(30) Foreign Application Priority Data
Jun. 15, 2012 (JP) 2012-135855

(51) Int. Cl. C09K 3/16

(52) U.S. Cl. CPC C09K 3/16
USPC 428/221; 216/67

(57) ABSTRACT

A polyester molded body includes a core containing a polyester and a surface layer portion covering the core, wherein the surface layer portion contains carbon nanotubes and an ionic liquid, the carbon nanotubes being three-dimensionally entangled in the polyester. A polyester molded body includes a core containing a polyester, an intermediate layer covering the core, and a surface layer portion covering the intermediate layer, wherein the intermediate layer contains carbon nanotubes and an ionic liquid, the carbon nanotubes being three-dimensionally entangled in the polyester, and the surface layer portion contains three-dimensionally entangled carbon nanotubes.

### BACKGROUND OF THE INVENTION

1. Field of the Invention

The present invention relates to a polyester molded body having excellent flame retardancy, antistaticity, and mechanical characteristics and a method for producing the polyester molded body.

2. Description of the Related Art

In recent years, in the fields of various apparatuses including precision electrical and electronic control components, antistatic resin formed products have been used in parts, sheets, and films for which there are electrostatic hazards. In working situations where electrostatic hazards may occur, work clothes made of antistatic high-density fabric are used. Thus, there will be increasing demands for formed articles of polyester antistatic resins having relatively high heat resistance, low environmental load, and high durability. With growing demands, antistatic polyester molded bodies will require further increases in functionality, more specifically, excellent antistatic characteristics as well as excellent flame retardancy and mechanical characteristics.

Antistatic polyester molded bodies require low surface resistivity (ohms per square) and a short static half-life (seconds). There is also a demand for excellent flame retardancy and mechanical characteristics. In particular, in order to achieve a short half-life, an antistatic resin formed product must have uniformly distributed electrically conductive paths on its surface. There are formed products containing electrically conductive filler, such as carbon black, in order to impart antistaticity to polyesters. However, these formed products must contain a relatively large amount of electrically conductive filler. This causes a deterioration in the mechanical characteristics of the polyesters. Furthermore, because of unevenly distributed electrically conductive paths on the surface of the formed products, it is difficult to impart excellent antistaticity to the polyesters. A technique for imparting flame retardancy to a polyester having excellent antistaticity has not been disclosed.

In order to solve the problems of existing antistatic polyester molded bodies, Japanese Patent Laid-Open No. 2006-036809 discloses a flame-retardant antistatic polyester resin composition that contains a thermoplastic polyester resin, an antistatic material, and a melamine-cyanuric acid compound.

Japanese Patent Laid-Open No. 2010-100971 discloses an electrically conductive fibrous structure that contains carbon black having a controlled particle size, a controlled structure, and controlled surface properties in an aromatic polyester. The fibrous structure has a surface resistivity in the range of 10⁰ to 10⁷ ohms per square and is composed of electrically conductive fiber having excellent mechanical characteristics.

However, these patents cannot provide a polyester molded body having excellent flame retardancy and mechanical characteristics and persistently having excellent antistaticity.

Although an antistatic polyester molded body described in Japanese Patent Laid-Open No. 2006-036809 has improved flame retardancy because of the melamine-cyanuric acid compound, it is difficult to achieve a surface resistivity in the range of 10⁰ to 10⁷ ohms per square. It is also difficult to improve the mechanical characteristics of the antistatic polyester molded body.

Japanese Patent Laid-Open No. 2010-100971 discloses an electrically conductive fibrous structure that contains carbon black having a controlled particle size, a controlled structure, and controlled surface properties in an aromatic polyester. The fibrous structure has a surface resistivity in the range of 10⁰ to 10⁷ ohms per square and is composed of electrically conductive fiber having excellent mechanical characteristics. However, it is difficult to improve flame retardancy. The addition of a flame retardant impairs formability of the fiber and makes it difficult to achieve a surface resistivity in the range of 10⁰ to 10⁷ ohms per square.

### SUMMARY OF THE INVENTION

In view of the background art, the present invention provides a polyester molded body having excellent flame retardancy, antistaticity, and mechanical characteristics, and a method for producing the polyester molded body.

A first polyester molded body that can solve the problems described above includes a core containing a polyester and a surface layer portion covering the core. The surface layer portion contains carbon nanotubes and an ionic liquid. The carbon nanotubes are three-dimensionally entangled in the polyester.

A second polyester molded body that can solve the problems described above includes a core containing a polyester, an intermediate layer covering the core, and a surface layer portion covering the intermediate layer. The intermediate layer contains carbon nanotubes and an ionic liquid. The carbon nanotubes are three-dimensionally entangled in the polyester. The surface layer portion contains three-dimensionally entangled carbon nanotubes.

A method for producing the first polyester molded body that can solve the problems described above includes extruding polyester pellets and pellets containing a polyester, carbon nanotubes, and an ionic liquid such that the polyester pellets are extruded as a core, thereby forming a molded body having a surface skin layer, and removing the polyester from the skin layer of the molded body.

A method for producing the second polyester molded body that can solve the problems described above includes extruding polyester pellets and pellets containing a polyester, carbon nanotubes, and an ionic liquid such that the polyester pellets are extruded as a core, thereby forming a molded body having a surface skin layer, removing the polyester and the ionic liquid from the skin layer of the molded body, and removing the polyester and the ionic liquid from a surface layer portion containing the polyester, the carbon nanotubes, and the ionic liquid.

Further features of the present invention will become apparent from the following description of exemplary embodiments with reference to the attached drawings.

### BRIEF DESCRIPTION OF THE DRAWINGS

FIGS. 1A and 1B are schematic cross-sectional views of an electrically conductive fiber according to an embodiment of the present invention.

FIGS. 2A and 2B are schematic cross-sectional views of an electrically conductive film according to an embodiment of the present invention.

FIG. 3A is a schematic view of carbon nanotubes dispersed in a cross section of an electrically conductive fiber according to an embodiment of the present invention.

FIG. 3B is a schematic view of carbon nanotubes dispersed in a cross section of an electrically conductive film according to an embodiment of the present invention.

FIGS. 4A and 4B are schematic views of a core-sheath composite nozzle for use in a production method according to an embodiment of the present invention.

FIG. 5 is a schematic view of a hot drawing apparatus for use in a production method according to an embodiment of the present invention.

### DESCRIPTION OF THE EMBODIMENTS

Although embodiments of a polyester molded body having excellent antistaticity, flame retardancy, and mechanical characteristics according to the present invention will be described below, the present invention is not limited to these embodiments. A polyester molded body in the present invention may be described as a polyester formed product. A polyester may be described as a polyester-resin.

A first polyester molded body according to the present invention includes a core containing a polyester and a surface layer portion covering the core. The surface layer portion contains carbon nanotubes and an ionic liquid. The carbon nanotubes are three-dimensionally entangled in the polyester.

A second polyester molded body according to the present invention includes a core containing a polyester, an intermediate layer covering the core, and a surface layer portion covering the intermediate layer. The intermediate layer contains carbon nanotubes and an ionic liquid. The carbon nanotubes are three-dimensionally entangled in the polyester. The surface layer portion contains three-dimensionally entangled carbon nanotubes.

A polyester molded body according to an embodiment of the present invention has a surface layer portion, which contains three-dimensionally entangled carbon nanotubes and an ionic liquid in a polyester. Thus, the polyester molded body has excellent flame retardancy and a surface resistivity in the range of 10⁰ to 10⁷ ohms per square.

A polyester molded body according to an embodiment of the present invention has a core containing a polyester and a surface layer portion covering the core. The surface layer portion contains three-dimensionally entangled carbon nanotubes and an ionic liquid in a polyester. Thus, the polyester molded body has excellent mechanical characteristics.

A polyester molded body according to an embodiment of the present invention is produced by bringing a molten polyester core into contact with a molten surface layer portion and solidifying the product. The molten surface layer portion is produced by sufficiently mixing molten polyester with the ionic liquid and the carbon nanotubes. This production process allows drawing treatment at a high drawing ratio in a hot drawing step, thereby realizing a mechanically excellent polyester molded body.

Embodiments of the present invention will be described below with reference to the attached drawings.

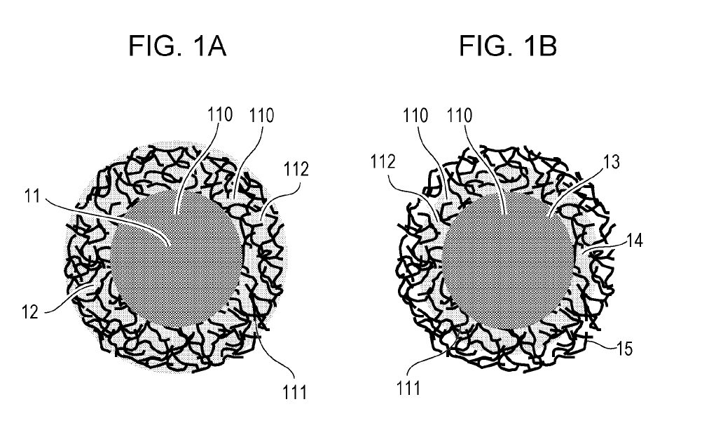

FIGS. 1A and 1B are schematic cross-sectional views of an electrically conductive fiber of an antistatic fibrous structure, which is an antistatic polyester molded body according to an embodiment of the present invention. FIG. 1A is a schematic cross-sectional view of an electrically conductive fiber having a two-layer structure composed of a core and a surface layer portion. FIG. 1B is a schematic cross-sectional view of an electrically conductive fiber having a three-layer structure composed of a core, an intermediate layer, and a surface layer portion.

In FIG. 1A, a core 11 is composed of a polyester 110 alone. The core 11 is covered with a surface layer portion 12. The surface layer portion 12 contains three-dimensionally entangled carbon nanotubes 111 in the polyester 110 in which an ionic liquid 112 is uniformly dispersed.

In FIG. 1B, a core 13 is composed of the polyester 110 alone. The core 13 is covered with an intermediate layer 14. The intermediate layer 14 contains the three-dimensionally entangled carbon nanotubes 111 in the polyester 110 in which the ionic liquid 112 is uniformly dispersed. The intermediate layer 14 is covered with a surface layer portion 15, which contains the three-dimensionally entangled carbon nanotubes 111.

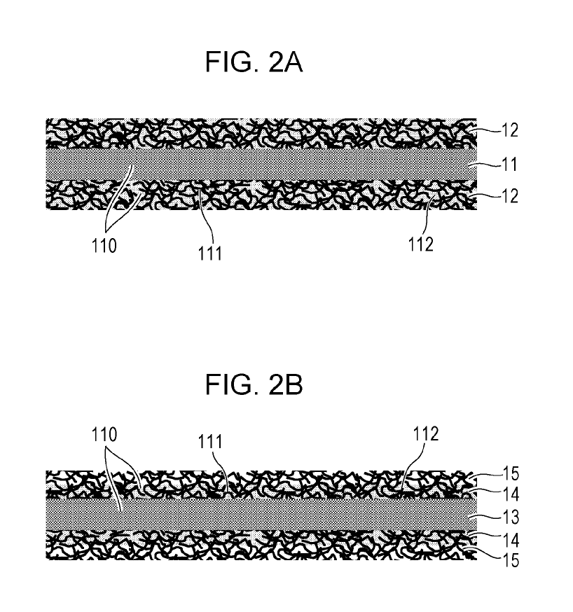

FIGS. 2A and 2B are schematic cross-sectional views of an electrically conductive film, which is an antistatic polyester molded body according to an embodiment of the present invention.

FIG. 2A is a schematic cross-sectional view of an electrically conductive film having a two-layer structure composed of a core and a surface layer portion. FIG. 2B is a schematic cross-sectional view of an electrically conductive film having a three-layer structure composed of a core, an intermediate layer, and a surface layer portion.

In FIG. 2A, a core 11 is composed of a polyester 110 alone. The core 11 is covered with a surface layer portion 12. The surface layer portion 12 contains three-dimensionally entangled carbon nanotubes 111 in the polyester 110 in which an ionic liquid 112 is uniformly dispersed.

In FIG. 2B, a core 13 is composed of the polyester 110 alone. The core 13 is covered with an intermediate layer 14. The intermediate layer 14 contains the three-dimensionally entangled carbon nanotubes 111 in the polyester 110 in which the ionic liquid 112 is uniformly dispersed. The intermediate layer 14 is covered with a surface layer portion 15, which contains the three-dimensionally entangled carbon nanotubes 111.

An ionic liquid according to an embodiment of the present invention is a constituent of the surface layer portion illustrated in FIGS. 1A and 2A and the intermediate layer illustrated in FIGS. 1B and 2B. The ionic liquid is a salt composed of ions and contains cations and anions. The cations may be one or two or more selected from an imidazolium ion, a pyridinium ion, a quaternary ammonium ion, and a quaternary phosphonium ion. The anions may be an anion having a fluoro group, such as CF₃SO₃ or (CF₃SO₂)₂N, which has high thermal stability.

The ionic liquid is liquid in the vicinity of room temperature and is therefore also referred to as an ambient temperature molten salt. Even in a liquid state, because of interaction between ions, the ionic liquid has little vapor pressure and is nonvolatile, flame retardant, and electrically conductive.

It is desirable that the ionic liquid content of a surface layer portion or an intermediate layer of a polyester molded body according to an embodiment of the present invention is 0.05% by weight or more and 3.0% by weight or less, preferably 0.1% by weight or more and 2.0% by weight or less. An ionic liquid content of less than 0.05% by weight results in difficult hot drawing at a high drawing ratio in a hot drawing process. Thus, the molded body rarely has excellent mechanical characteristics. Extrusion is performed while molten polyester of the core is in contact with the surface layer portion containing the carbon nanotubes and the ionic liquid uniformly dispersed in molten polyester in an extrusion molding machine. When the ionic liquid content of the surface layer portion is more than 3.0% by weight, this results in a large difference in melt viscosity between the molten material of the surface layer portion and the polyester of the core, causing a marked deterioration in formability. A viscosity-reducing agent may be added to the polyester of the core to reduce the difference in melt viscosity between the surface layer portion and the core. The viscosity-reducing agent can improve formability in extrusion but makes it difficult to produce a molded body having excellent mechanical characteristics.

A polyester molded body according to an embodiment of the present invention may be a fiber, a piece of cloth, or a film.

In order to control its surface resistivity and improve its mechanical characteristics, an electrically conductive fiber or an electrically conductive film, which is an antistatic polyester molded body according to an embodiment of the present invention, is subjected to hot drawing treatment for oriented crystallization of the polyester. A higher drawing ratio in hot drawing results in a higher degree of oriented crystallization and markedly improved mechanical characteristics.

As illustrated in FIGS. 1A and 2A, an electrically conductive fiber or an electrically conductive film, which is an antistatic polyester molded body according to an embodiment of the present invention, contains carbon nanotubes in its surface layer portion. The breaking stress of the fiber and the film illustrated in FIGS. 1A and 2A is lower in the surface layer portion containing carbon nanotubes in a polyester than in the polyester core. This means that the breaking stress of the fiber and the film illustrated in FIGS. 1A and 2A depends on the breaking stress of the surface layer portion containing carbon nanotubes in a polyester. When the surface layer portion contains no ionic liquid, the surface layer portion containing carbon nanotubes acts as an origin of breakage in hot drawing treatment, and the hot drawing ratio cannot be increased. Thus, it is difficult to improve the mechanical characteristics of the electrically conductive fiber or the electrically conductive film after hot drawing treatment.

When the surface layer portion illustrated in FIGS. 1A and 2A contains an ionic liquid, the drawing ratio in hot drawing can be much higher than the drawing ratio in the case that the surface layer portion contains no ionic liquid without causing breakage. Thus, the electrically conductive fiber and the electrically conductive film after hot drawing treatment can have significantly improved mechanical characteristics.

Although the effects of the ionic liquid are not clear in detail, it is supposed that the ionic liquid in the polyester containing carbon nanotubes can control the melt structure of the polyester without changing the dispersed state of the carbon nanotubes in the polyester and consequently reduce molecular orientation and crystallization of the polyester. This allows drawing at a high drawing ratio in hot drawing in the downstream process. Thus, the electrically conductive fiber and the electrically conductive film have significantly improved mechanical characteristics.

The ionic liquid to be mixed with molten polyester may have a decomposition temperature of 300° C. or more. The ionic liquid having a decomposition temperature of less than 300° C. may impair formability and cause a marked deterioration in the mechanical characteristics of the formed product.

Furthermore, uniform dispersion of the ionic liquid in molten polyester can improve the mechanical characteristics and stability of the formed product. Thus, the ionic liquid content has an upper limit that depends on the type of ionic liquid. Uniform dispersion of the ionic liquid in polyester can be confirmed by mixing molten polyester with the ionic liquid, continuously extruding the polyester from a nozzle of an extrusion molding machine, cooling the formed product in water, and ensuring that the cooled product is transparent and no ionic liquid floats on the surface of the cooling water. An opaque cooled product possibly indicates that the ionic liquid is unevenly dispersed in the polyester and partly aggregates. When the ionic liquid is poorly dispersed in the polyester, part of the ionic liquid not dispersed in the polyester may aggregate on the surface of the formed product and float on the surface of the cooling water.

Electrically conductive fibers constituting an antistatic fibrous structure or an electrically conductive film constituting an antistatic formed product, which is a polyester molded body according to an embodiment of the present invention, includes a surface layer portion that contains three-dimensionally entangled carbon nanotubes in a polyester in which an ionic liquid is uniformly dispersed or a surface layer portion that contains three-dimensionally entangled carbon nanotubes alone. Thus, in addition to excellent mechanical characteristics, the electrically conductive fibers or the electrically conductive film has a surface resistivity in the range of 10⁰ to 10⁷ ohms per square.

In the presence of the ionic liquid, the electrically conductive fibers or the electrically conductive film can have flame retardancy and excellent antistatic characteristics.

The carbon nanotubes of the surface layer portions illustrated in FIGS. 1A and 2A and the intermediate layers and the surface layer portions illustrated in FIGS. 1B and 2B may have a length L of 5 μm or less and 1 μm or more and an aspect ratio L/D of 400 or less and 150 or more. The aspect ratio L/D is a ratio of the length L to the diameter D of the carbon nanotubes.

When the carbon nanotubes have a length L of 5 μm or less and an aspect ratio L/D of 400 or less, in an electrically conductive fiber produced by hot-drawing an undrawn fiber produced by a melt spinning method, the orientation of the carbon nanotubes in the spinning direction of the fiber can be reduced, and the carbon nanotubes of the surface layer portion illustrated in FIG. 1A and the intermediate layer and the surface layer portion illustrated in FIG. 1B can be highly three-dimensionally entangled in each other.

Furthermore, when the carbon nanotubes have a length L of 5 μm or less and an aspect ratio L/D of 400 or less, in an electrically conductive film produced by stretching an unstretched film, for example, produced by a melt extrusion method or an injection molding method, the orientation of the carbon nanotubes in the stretching direction of the film can be reduced. Thus, the carbon nanotubes of the surface layer portion illustrated in FIG. 2A and the intermediate layer and the surface layer portion illustrated in FIG. 2B can be highly three-dimensionally entangled in each other.

Specific examples of the carbon nanotubes include monolayer carbon nanotubes, which are cylindrical tubes composed of a single graphene, and multilayer carbon nanotubes, which are cylindrical tubes composed of two or more graphenes having different diameters.

The surface layer portions illustrated in FIGS. 1A and 2A and the intermediate layers and the surface layer portions illustrated in FIGS. 1B and 2B may contain carbon black as an electrically conductive filler instead of carbon nanotubes. In order to control the surface resistivity of the polyester molded body in the range of 10⁰ to 10⁷ ohms per square, however, the carbon black content must be in the range of 20% to 50% by weight. At such a carbon black content, it is difficult to impart excellent mechanical characteristics to the polyester molded body.

In contrast, when carbon nanotubes are used as an electrically conductive filler, in a polyester molded body according to an embodiment of the present invention, the carbon nanotube content of each of the surface layer portions illustrated in FIGS. 1A and 2A and the intermediate layers illustrated in FIGS. 1B and 2B is in the range of 2% by weight or more and 10% by weight or less, preferably 2.5% by weight or more and 8.0% by weight or less.

Examples of the polyester(s) of the cores and the surface layer portions illustrated in FIGS. 1A and 2A and the cores and intermediate layers illustrated in FIGS. 1B and 2B include poly(ethylene terephthalate), poly(trimethylene terephthalate), poly(butylene terephthalate), poly(ethylene naphthalate), and poly(butylene naphthalate). The polyester(s) may be a mixture of two or more polyesters.

A method for producing a polyester molded body according to an embodiment of the present invention will be described below.

A method for producing a polyester molded body illustrated in FIGS. 1A and 2A includes extruding polyester pellets and pellets containing a polyester, carbon nanotubes, and an ionic liquid such that the polyester pellets are extruded as a core, thereby forming a formed product having a surface skin layer, and removing the polyester from the skin layer of the molded body.

A method for producing a polyester molded body illustrated in FIGS. 1B and 2B includes extruding polyester pellets and pellets containing a polyester, carbon nanotubes, and an ionic liquid such that the polyester pellets are extruded as a core, thereby forming a formed product having a surface skin layer, removing the polyester from the skin layer of the formed product, and removing the polyester and the ionic liquid from a surface layer portion containing the polyester, the carbon nanotubes, and the ionic liquid.

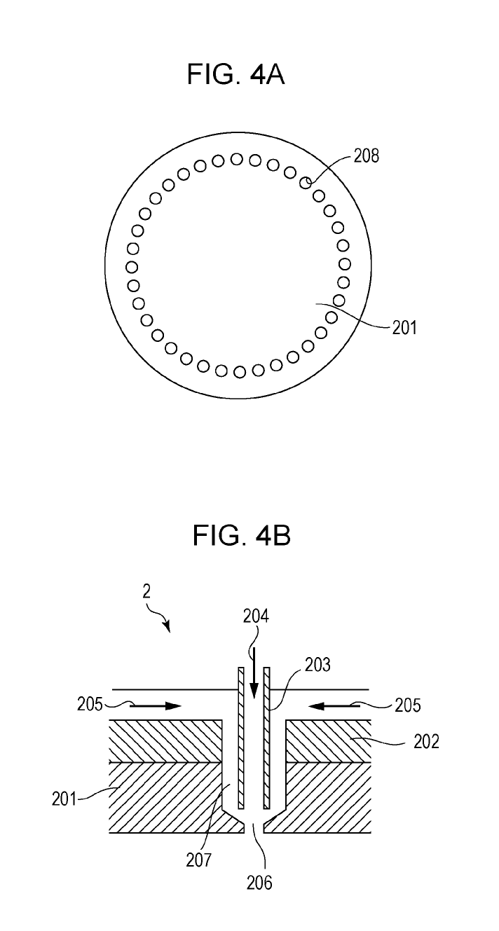

An electrically conductive fiber of an antistatic fibrous structure, which is an antistatic polyester molded body according to an embodiment of the present invention, can be produced by a melt spinning method. In accordance with the melt spinning method, the electrically conductive fiber in a molten state is extruded from a core-sheath composite nozzle illustrated in FIGS. 4A and 4B. FIG. 4A is a front view of the core-sheath composite nozzle, and FIG. 4B is a fragmentary sectional view of the core-sheath composite nozzle. A core-sheath composite nozzle 2 includes a mouthpiece plate 201 having 36 circular openings 208 and a distribution plate 202 having distribution openings corresponding to the circular openings 208. The mouthpiece plate 201 is bonded to the distribution plate 202. A pipe 203 for supplying a core polyester-resin 204 passes through each of the distribution openings. A polyester-resin 205 containing carbon nanotubes and an ionic liquid flows through a sheath 207 around the pipe 203. Thus, molten resins are extruded in a core-sheath form from a circular spinneret 206 of the mouthpiece plate 201.

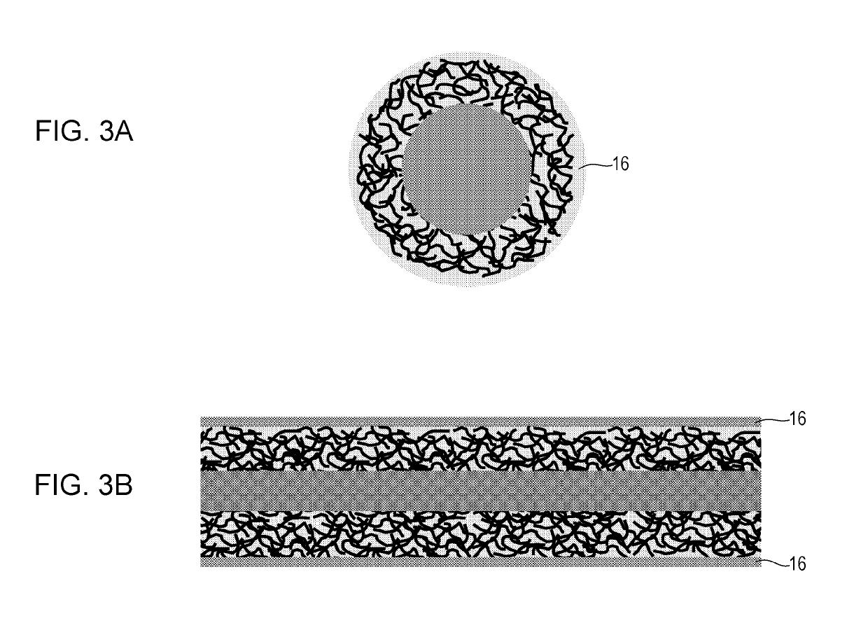

In a cooling process after extrusion from the spinneret 206, an electrically conductive fiber illustrated in FIG. 3A is formed. The electrically conductive fiber includes a polyester-resin core, a sheath covering the core and containing the ionic liquid and the carbon nanotubes in the polyester-resin 205, and an outermost layer 16 covering the sheath and containing the polyester-resin 205.

The formation of the outermost layer 16 containing the polyester-resin 205 will be described below. A tip of molten resin flowing over an inner surface of a mouthpiece (circular opening) of the core-sheath composite nozzle spouts from the center of a cross section of the mouthpiece to the inner surface of the mouthpiece. This is referred to as a fountain flow. The molten resin is quenched on the inner surface of the mouthpiece to form a skin layer. When the molten resin contains filler including carbon nanotubes, the skin layer does not contain the filler including carbon nanotube and is formed of the resin alone.

A molten electrically conductive fiber having a skin layer on its surface extruded from the melt spinning nozzle is cooled, is treated with an aqueous or non-aqueous agent, and is preferably wound at a take-up speed of 100 m/min or more and 10000 m/min or less, more preferably 300 m/min or more and 2000 m/min or less. The fiber extruded from the melt spinning nozzle is preferably multifilament yarn composed of a plurality of fibers rather than a monofilament. The number of monofilaments is preferably in the range of 20 to 200.

An undrawn electrically conductive fiber produced by the melt spinning method may be hot-drawn with a hot drawing apparatus to form a crystal-oriented electrically conductive fiber.

The ionic liquid in the polyester containing carbon nanotubes surrounded by the skin layer allows hot drawing at a high drawing ratio to form an electrically conductive fiber having excellent mechanical characteristics.

In the case of an electrically conductive fiber produced with a melt spinning nozzle, a skin layer 16 is disposed on the surface of a hot-drawn electrically conductive fiber, as illustrated in FIG. 3A. Thus, an electrically conductive fibrous structure of the electrically conductive fiber rarely has a surface resistivity of 10⁷ ohms or less. In order to remove the skin layer and selectively remove the polyester and the ionic liquid from the polyester-resin layer containing the carbon nanotubes and the ionic liquid disposed within the skin layer, oxygen plasma treatment or alkaline water solution treatment is suitably used.

In the oxygen plasma treatment, an oxygen gas is introduced into a vacuum chamber under reduced pressure. Oxygen plasma is induced between the vacuum chamber and a porous metal cylindrical electrode disposed in the vacuum chamber so as to treat a surface of an electrically conductive fiber or an electrically conductive film disposed in the porous metal cylindrical electrode. Ions or electrons in the plasma can be controlled to remove the skin layer on the surface of the electrically conductive fiber or the electrically conductive film in the porous metal cylindrical electrode with oxygen atom radicals. The conditions for plasma generation depend on the device configuration and the size of substance to be treated. A high-frequency power may be 30 W or more and 500 W or less. The oxygen gas flow rate may be 30 sccm or more and 200 sccm or less.

The oxygen plasma treatment time may be 2 minutes or more and 60 minutes or less. An oxygen plasma treatment time of less than 2 minutes results in insufficient oxygen plasma treatment. An oxygen plasma treatment time of more than 60 minutes results in low treatment efficiency because of an increase in temperature.

The alkaline water solution treatment is preferably performed at 50° C. or more and 100° C. or less in 1% by weight or more and 6% by weight or less sodium hydroxide solution or potassium hydroxide solution for several tens of minutes to several hundreds of minutes, more preferably at a temperature in the range of 60° C. to 70° C. in 3% to 5% by weight sodium hydroxide solution for 100 to 300 minutes.

An electrically conductive fiber having a two-layer structure of a core and a surface layer portion as illustrated in FIG. 1A or an electrically conductive fiber having a three-layer structure of a core, an intermediate layer, and a surface layer portion as illustrated in FIG. 1B can be produced with a core-sheath composite melt spinning nozzle by controlling the oxygen plasma treatment or alkaline water solution treatment time. The surface resistivity of an antistatic fibrous structure of the electrically conductive fiber can be controlled in the range of 10³ to 10⁷ ohms per square. The ionic liquid can also impart flame retardancy to the polyester molded body.

An electrically conductive film of an antistatic molded body, which is an antistatic polyester molded body according to an embodiment of the present invention, can be produced by a coextrusion method, which is one of melt extrusion methods. Polyester pellets and pellets containing carbon nanotubes and an ionic liquid uniformly dispersed in a polyester are extruded from three extruders through a T-die such that the polyester forms a core and the carbon nanotubes and the ionic liquid uniformly dispersed in the polyester form a surface layer portion. The molten resins from the three extruders form a three-layer structure just before a T-die lip. The three-layer structure is continuously extruded from the lip and is cooled.

In the production of the electrically conductive film by the coextrusion method, the carbon nanotubes and the ionic liquid uniformly dispersed in molten polyester flow over the inner surface of the T-die and are extruded from the die lip. While the carbon nanotubes and the ionic liquid uniformly dispersed in molten polyester flow over the inner surface of the T-die, the tip of the molten resin spouts from the center of a cross section of the lip to the inner surface of the mouthpiece (fountain flow). The molten resin is quenched on the inner surface of the lip to form a skin layer. The skin layer contains no carbon nanotube and is formed only of the polyester containing the ionic liquid.

An unstretched electrically conductive film produced by the coextrusion method is hot-stretched with a heating-type biaxial stretching machine in the longitudinal direction and the transverse direction of the film to form a crystal-oriented electrically conductive film.

The ionic liquid in the polyester containing carbon nanotubes surrounded by the skin layer allows hot stretching at a high stretch ratio to form an electrically conductive film having excellent mechanical characteristics.

As illustrated in FIG. 3B, the skin layer 16 is disposed on the surface of the hot-stretched electrically conductive film. Thus, the electrically conductive film rarely has a surface resistivity of 10³ ohms or less. In order to remove the skin layer and selectively remove the polyester and the ionic liquid from the polyester layer containing the carbon nanotubes and the ionic liquid disposed within the skin layer, oxygen plasma treatment or alkaline water solution treatment is suitably used.

An electrically conductive film having a two-layer structure illustrated in FIG. 2A or an electrically conductive film having a three-layer structure illustrated in FIG. 2B can be formed by controlling the oxygen plasma treatment or alkaline water solution treatment time. The surface resistivity of the antistatic molded body can be controlled in the range of 10⁰ to 10⁷ ohms per square by controlling the oxygen plasma treatment or alkaline water solution treatment time. The ionic liquid can also impart flame retardancy to the polyester molded body.

### EXAMPLES

The examples of the present invention will be described below. However, the present invention is not limited to these examples.

### Examples 1 to 3

Poly(ethylene terephthalate) resin pellets having an intrinsic viscosity (hereinafter referred to as IV) of 0.8, a diameter of 3 mm, and a length of 5 mm and a 1-ethylpyridinium bis(trifluoromethanesulfonyl)imide (hereinafter referred to as an ionic liquid E-1), which is an ionic liquid having a thermal decomposition temperature of 370° C., were melt-kneaded and extruded as a strand with a twin-screw extruder. The 1-ethylpyridinium bis(trifluoromethanesulfonyl)imide constituted 0.2% by weight of the mixture. The strand was cooled with water and was cut with a cutter blade to prepare pellets (hereinafter referred to as pellets A1) containing the ionic liquid uniformly dispersed in the poly(ethylene terephthalate) resin compound. The strand cooled with water was transparent, and no liquid substance floated on the surface of the cooling water.

The pellets A1 were freeze-ground and classified to prepare a fine powder having a particle size of 150 μm or less. The poly(ethylene terephthalate) resin fine powder having a particle size of 150 μm or less was dry-blended with carbon nanotubes having a length of 5 μm or less, an average length of 3 μm, an aspect ratio of 400 or less, and an average aspect ratio of 200. The carbon nanotubes constituted 4% by weight of the mixture. The mixture was kneaded and melted with a twin-screw extruder to prepare pellets (hereinafter referred to as pellets B) containing the carbon nanotubes and 1-ethylpyridinium bis(trifluoromethanesulfonyl)imide uniformly dispersed in the poly(ethylene terephthalate) resin compound.

Poly(ethylene terephthalate) resin pellets having IV of 0.95 (hereinafter referred to as pellets C) and the pellets B were dried at 140° C. for 4 hours. Immediately after drying, the pellets C and the pellets B were supplied to two twin-screw extruders such that the pellets C formed a core and the pellets B formed a sheath. Molten materials of the pellets C and the pellets B were spun at a spinning temperature of 290° C. from a core-sheath composite nozzle having 36 mouthpieces (circular openings) each having a caliber of 0.3 mm. The area ratio of the core to the sheath was 5:5. The resulting yarn having a core-sheath structure was solidified with cooling air at an air temperature of 25° C. and an air velocity of 0.5 mm/s in a cooling apparatus having a cooling length of 1 m. The yarn was treated with an oil solution (effective component concentration: 10% by weight) and was wound at 1000 m/min to yield undrawn multifilament yarn 310 having a fiber diameter of 34 μm. Spinnability in melt spinning and drawability at a take-up speed of 1000 m/min were satisfactory.

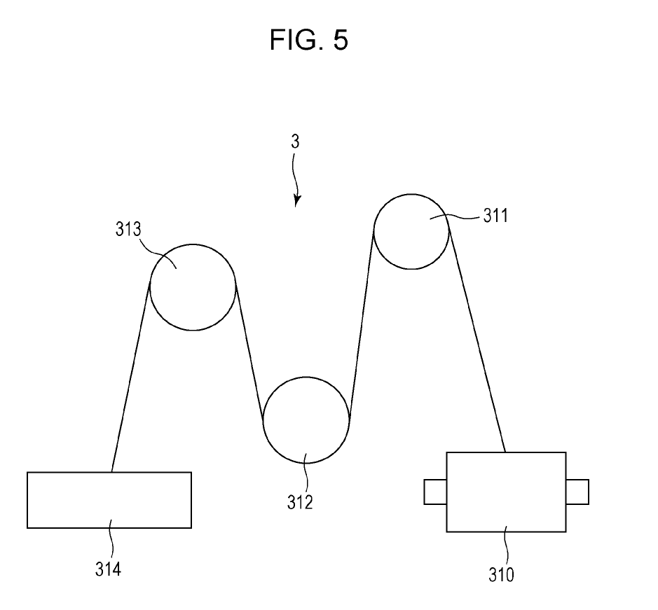

The unstretched multifilament yarn 310 was drawn with a hot drawing apparatus illustrated in FIG. 5 to yield drawn yarn having different drawing ratios and composed of 36 filaments. In FIG. 5, the temperature of a first roller 312 was 100° C., the temperature of a second roller 313 was 150° C., and the take-up speed of the second roller 313 was 400 m/min. The take-up speed of the first roller 312 was changed to produce drawn multifilament yarn at drawing ratios of 3.5, 4.0, and 4.5. Drawability in hot drawing was satisfactory.

An electrically conductive fiber was taken from each drawn multifilament yarn having a drawing ratio of 3.5, 4.0, or 4.5 and was subjected to oxygen plasma treatment. After the oxygen plasma treatment, a cross section of the electrically conductive fiber was observed by scanning electron microscopy (SEM), and an element mapping image with respect to carbon, oxygen, sulfur, and fluorine was taken. The SEM observation showed that the polyester resin core and the surface layer portion covering the core contained three-dimensionally entangled carbon nanotubes dispersed in the polyester-resin.

The element mapping image showed that carbon, oxygen, sulfur, and fluorine were present on the entire surface of the surface layer portion. Since sulfur and fluorine were not present on the carbon nanotubes but constituted the ionic liquid E-1, this indicated that the ionic liquid was present over the entire surface of the surface layer portion of the electrically conductive fiber.

The tensile moduli of the electrically conductive fibers having drawing ratios of 3.5, 4.0, and 4.5 were measured with a micro strength evaluation testing machine Micro Autograph MST-I manufactured by Shimadzu Corp. The tensile moduli of the electrically conductive fibers having drawing ratios of 3.5, 4.0, and 4.5 were as high as 6.2, 6.9, and 7.1 GPa, respectively.

High-density fabrics were then manufactured using the drawn multifilament yarn having drawing ratios of 3.5, 4.0, and 4.5 as the warp and the weft. The high-density fabrics manufactured using the drawn multifilament yarn having drawing ratios of 3.5, 4.0, and 4.5 had surface resistivities of 10⁷ ohms per square or less, more specifically, 2.0×10⁶, 3.0×10⁶, and 3.5×10⁶ ohms per square, respectively.

The flame retardancy of the drawn multifilament yarn having drawing ratios of 3.5, 4.0, and 4.5 was evaluated by an oxygen index combustion test method. The drawn multifilament yarn having drawing ratios of 3.5, 4.0, and 4.5 had oxygen indexes of 20.0, 20.5, and 21.0, respectively. Thus, the drawn multifilament yarn had improved flame retardancy.

Thus, the resulting antistatic polyester molded body had excellent mechanical characteristics, low surface resistivity, and high flame retardancy.

### Examples 4 to 6

As shown in Table 1, production of drawn multifilament yarn, removal of the skin layer, sampling of an electrically conductive fiber, SEM observation, and element mapping were performed in the same manner as in Examples 1 to 3 except that the skin layer was removed by alkaline water solution treatment. The SEM observation showed that the polyester-resin core and the intermediate layer covering the core contained three-dimensionally entangled carbon nanotubes dispersed in the polyester-resin and that the surface layer portion covering the intermediate layer contained three-dimensionally entangled carbon nanotubes.

After removal of the skin layer, the tensile modulus of an electrically conductive fiber was measured. Table 1 shows the results.

Production of drawn multifilament yarn, removal of the skin layer, and measurement of the oxygen index were performed in the same manner as in Examples 1 to 3. Table 1 shows the results.

Furthermore, after the production of drawn multifilament yarn, the removal of the skin layer, and the production of a high-density fabric, the surface resistivity of the high-density fabric was measured. Table 1 shows the results.

Thus, the resulting antistatic polyester molded body had excellent mechanical characteristics, low surface resistivity, and high flame retardancy.

### Example 7

As shown in Table 1, treatment was performed in the same manner as in Examples 4 to 6 except that the drawing ratio in hot drawing was 4.5. After the treatment, the properties described in Examples 4 to 6 except for SEM observation and element mapping measurement were evaluated. Table 1 shows the results.

Thus, the resulting antistatic polyester molded body had excellent mechanical characteristics, low surface resistivity, and high flame retardancy.

### Examples 8 and 9

As shown in Table 1, treatment was performed in the same manner as in Example 6 except that the ionic liquid E-1 content was changed. After the treatment, the properties described in Example 6 except for SEM observation and element mapping measurement were evaluated. Table 1 shows the results.

Thus, the resulting antistatic polyester molded body had excellent mechanical characteristics, low surface resistivity, and high flame retardancy.

### Examples 10 and 11

As shown in Table 1, treatment was performed in the same manner as in Example 6 except that the ionic liquid E-1 content and the carbon nanotube content were changed. After the treatment, the properties described in Example 6 except for SEM observation and element mapping measurement were evaluated. Table 1 shows the results.

Thus, the resulting antistatic polyester molded body had excellent mechanical characteristics, low surface resistivity, and high flame retardancy.

### Examples 12 and 13

As shown in Table 1, treatment was performed in the same manner as in Example 6 except that the ionic liquid was changed to 1-ethyl-3-methylimidazolium bis(trifluoromethanesulfonyl)imide (hereinafter referred to as an ionic liquid E-2), which has a thermal decomposition temperature of 370° C., and 1-ethyl-3-methylimidazolium bis(nonafluorobutanesulfonyl)imide (hereinafter referred to as an ionic liquid E-3), which has a thermal decomposition temperature of 348° C. After the treatment, the properties described in Example 6 except for SEM observation and element mapping measurement were evaluated. Table 1 shows the results.

Thus, the resulting antistatic polyester molded body had excellent mechanical characteristics, low surface resistivity, and high flame retardancy.

### Comparative Example 1

As shown in Table 1, treatment was performed in the same manner as in Example 4 except that the surface layer portion of the fiber contained no ionic liquid. After the treatment, the properties described in Example 6 except for SEM observation and element mapping measurement were evaluated. Table 1 shows the results.

### Comparative Example 2

As shown in Table 1, treatment was performed in the same manner as in Comparative Example 1 except that the drawing ratio in hot drawing was changed. The resulting fiber was broken during hot drawing and could not be continuously hot-drawn.

### Comparative Example 3

As shown in Table 1, treatment was performed in the same manner as in Comparative Example 1 except that the carbon nanotube content was changed. The resulting fiber had poor spinnability in melt spinning, and an unstretched multifilament could not be produced.

In Table 1, circles in formability indicate that melt spinnability was satisfactory and an unstretched multifilament could be produced. Crosses in formability indicate that an unstretched multifilament could not be produced by melt spinning. Circles in drawability indicate that a drawn multifilament could be produced without breakage. Crosses in drawability indicate that a drawn multifilament could not be produced because of breakage.

### Example 14

Pellets (hereinafter referred to as pellets D) containing carbon nanotubes and an ionic liquid uniformly dispersed in a poly(ethylene terephthalate) resin compound were prepared in the same manner as in Example 1 except that the ionic liquid 1-ethylpyridinium bis(trifluoromethanesulfonyl)imide content was 0.7% by weight and the carbon nanotube content was 6.0% by weight.

The pellets C described in Example 1 and the pellets D were dried at 140° C. for 4 hours.

The pellets C and D were then melted in a single-screw extruder having a T-die. The single-screw extruder was heated to a temperature in the range of 280° C. to 290° C. The pellets C and D were extruded to form an unstretched film while a three-layered structure D/C/D was formed in the T-die.

The unstretched film was stretched at 150° C. in the longitudinal direction at a stretch ratio of 6 and then at 150° C. in the transverse direction at a stretch ratio of 6 to form a stretched film having a thickness of 80 μm. The thicknesses of the D/C/D layers of the stretched laminated film were 30/20/30 μm.

For alkaline water solution treatment, the stretched laminated film was immersed in 3% by weight aqueous sodium hydroxide at a temperature of 65° C. for 180 minutes while gently stirring. After the alkaline water solution treatment, the stretched laminated film was sufficiently washed with water and was dried at 70° C. for 90 minutes.

After the alkaline water solution treatment, the stretched laminated film had a surface resistivity of 6×10⁰ ohms per square.

### Comparative Example 4

Pellets (hereinafter referred to as pellets E) containing carbon nanotubes uniformly dispersed in a poly(ethylene terephthalate) resin compound were prepared in the same manner as in Example 1 except that the pellets contained no ionic liquid and the carbon nanotube content was 6.0% by weight.

The pellets C described in Example 1 and the pellets E were dried at 140° C. for 4 hours.

The pellets C and E were then melted in a single-screw extruder having a T-die. The single-screw extruder was heated to a temperature in the range of 280° C. to 290° C. The pellets C and E were extruded to form an unstretched film while a three-layered structure E/C/E was formed in the T-die.

The unstretched film was stretched at 150° C. in the longitudinal direction at a stretch ratio of 6. However, the unstretched film was broken, and no stretched film was formed.

TABLE 1

| Items | | | | Example 1 | Example 2 | Example 3 | Example 4 | Example 5 | Example 6 | Example 7 | Example 8 |
|---|---|---|---|---|---|---|---|---|---|---|---|
| Surface layer | Portion | | — | Surface layer | Surface layer | Surface layer | Intermediate | Intermediate | Intermediate | Intermediate | Intermediate |
| portion or | containing | | | portion | portion | portion | layer | layer | layer | layer | layer |
| intermediate | ionic liquid | | | | | | | | | | |
| layer of fiber | Ionic | Type | — | E-1 | E-1 | E-1 | E-1 | E-1 | E-1 | E-1 | E-1 |
| | liquid | Con- | wt % | 0.2 | 0.2 | 0.2 | 0.2 | 0.2 | 0.2 | 0.2 | 1.0 |
| | | tent | | | | | | | | | |
| | Carbon | | wt % | 4.0 | 4.0 | 4.0 | 4.0 | 4.0 | 4.0 | 4.0 | 4.0 |
| | nanotube | | | | | | | | | | |
| | content | | | | | | | | | | |
| | Polyester | | wt % | 95.8 | 95.8 | 95.8 | 95.8 | 95.8 | 95.8 | 95.8 | 95.0 |
| | content | | | | | | | | | | |
| | Thickness of | | μm | 2.5 | 2.4 | 2.3 | 2.0 | 1.9 | 1.8 | 1.7 | 1.6 |
| | surface layer | | | | | | | | | | |
| | portion | | | | | | | | | | |
| Diameter of fiber | | | μm | 18 | 17 | 16 | 20 | 18 | 17 | 16 | 17 |
| Formability | | | — | ◯ | ◯ | ◯ | ◯ | ◯ | ◯ | ◯ | ◯ |
| Drawability | Drawing | | — | 3.5 | 4.0 | 4.5 | 3.0 | 3.5 | 4.0 | 4.5 | 4.0 |
| | ratio | | | | | | | | | | |
| | Drawability | | — | ◯ | ◯ | ◯ | ◯ | ◯ | ◯ | ◯ | ◯ |
| Method for removing | | | — | Oxygen | Oxygen | Oxygen | Alkaline | Alkaline | Alkaline | Alkaline | Alkaline |
| skin layer | | | | plasma | plasma | plasma | water | water | water | water | water |
| | | | | treatment | treatment | treatment | solution | solution | solution | solution | solution |
| | | | | | | | treatment | treatment | treatment | treatment | treatment |
| Tensile modulus of | | | GPa | 6.2 | 6.9 | 7.1 | 4.8 | 6.3 | 7.1 | 7.3 | 6.9 |
| single fiber | | | | | | | | | | | |
| Surface resistivity | | | Ω/□ | 2.0 × 10⁶ | 3.0 × 10⁶ | 3.5 × 10⁶ | 9.0 × 10³ | 1.5 × 10⁴ | 1.8 × 10⁴ | 2.5 × 10⁴ | 1.5 × 10⁴ |
| of formed product | | | | | | | | | | | |
| produced using fiber | | | | | | | | | | | |
| Flame retardancy | | | — | 20.0 | 20.5 | 21.0 | 20.0 | 20.5 | 21.0 | 21.0 | 21.5 |
| of formed product | | | | | | | | | | | |
| produced using fiber | | | | | | | | | | | |
| Oxygen index | | | | | | | | | | | |
| | | | | | | | | | Comparative | Comparative | Comparative |
| Items | | | | Example 9 | Example 10 | Example 11 | Example 12 | Example 13 | example 1 | example 2 | example 3 |
| Surface layer | Portion | | — | Intermediate | Intermediate | Intermediate | Intermediate | Intermediate | — | — | — |
| portion or | containing | | | layer | layer | layer | layer | layer | | | |
| intermediate | ionic liquid | | | | | | | | | | |
| layer of fiber | Ionic | Type | — | E-1 | E-1 | E-1 | E-2 | E-3 | — | — | — |
| | liquid | Con- | wt % | 2.0 | 1.0 | 1.5 | 0.2 | 0.2 | — | — | — |
| | | tent | | | | | | | | | |

| | Carbon | wt % | 4.0 | 6.0 | 8.0 | 4.0 | 4.0 | 4.0 | 4.0 | 6.0 |
|---|---|---|---|---|---|---|---|---|---|---|
| | nanotube | | | | | | | | | |
| | content | | | | | | | | | |
| | Polyester | wt % | 94.0 | 93.0 | 91.5 | 95.8 | 95.8 | 96.0 | 96.0 | 94.0 |
| | content | | | | | | | | | |
| | Thickness of | μm | 1.6 | 2 | 1.9 | 1.8 | 1.8 | 2.8 | — | — |
| | surface layer | | | | | | | | | |
| | portion | | | | | | | | | |
| Diameter of fiber | | μm | 16 | 18 | 18 | 17 | 17 | 21 | — | — |
| Formability | | — | ◯ | ◯ | ◯ | ◯ | ◯ | ◯ | ◯ | X |
| Drawability | Drawing | — | 4.0 | 4.0 | 4.0 | 4.0 | 4.0 | 3.0 | 3.5 | — |
| | ratio | | | | | | | | | |
| | Drawability | — | ◯ | ◯ | ◯ | ◯ | ◯ | ◯ | X | — |

| | | | | | | | | | |
|---|---|---|---|---|---|---|---|---|---|
| Method for removing | — | Alkaline | Alkaline | Alkaline | Alkaline | Alkaline | Alkaline | — | — |
| skin layer | | water | water | water | water | water | water | | |
| | | solution | solution | solution | solution | solution | solution | | |
| | | treatment | treatment | treatment | treatment | treatment | treatment | | |
| Tensile modulus of | Gpa | 6.8 | 6.9 | 6.8 | 6.7 | 6.8 | 3.6 | — | — |
| single fiber | | | | | | | | | |
| Surface resistivity | Ω/□ | 1.0 × 10⁴ | 6.0 × 10³ | 3.5 × 10³ | 1.9 × 10⁴ | 1.5 × 10⁴ | 1.0 × 10⁴ | — | — |
| of formed product | | | | | | | | | |
| produced using fiber | | | | | | | | | |
| Flame retardancy | — | 21.5 | 21.0 | 21.0 | 20.5 | 21.0 | 19.0 | — | — |
| of formed product | | | | | | | | | |
| produced using fiber | | | | | | | | | |
| Oxygen index | | | | | | | | | |

A polyester molded body according to the present invention has excellent flame retardancy, antistaticity, and mechanical characteristics and can be used for high-performance fibers.

The present invention can provide a polyester molded body having excellent flame retardancy, antistaticity, and mechanical characteristics and a method for producing the polyester molded body.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-135855 filed Jun. 15, 2012, which is hereby incorporated by reference herein in its entirety.

What is claimed is:

1. A polyester molded body, comprising: a core containing a polyester; and a surface layer portion covering the core, wherein the surface layer portion contains carbon nanotubes and an ionic liquid, the carbon nanotubes being three-dimensionally entangled in the polyester.

2. A polyester molded body, comprising: a core containing a polyester; an intermediate layer covering the core; and a surface layer portion covering the intermediate layer, wherein the intermediate layer contains carbon nanotubes and an ionic liquid, the carbon nanotubes being three-dimensionally entangled in the polyester, and the surface layer portion contains three-dimensionally entangled carbon nanotubes.

3. The polyester molded body according to claim 1, wherein the ionic liquid has a thermal decomposition temperature of 300° C. or more.

4. The polyester molded body according to claim 2, wherein the ionic liquid has a thermal decomposition temperature of 300° C. or more.

5. The polyester molded body according to claim 1, wherein the ionic liquid is one or two or more selected from imidazolium salts, pyridinium salts, quaternary ammonium salts, and quaternary phosphonium salts.

6. A polyester molded body according to claim 1, wherein the polyester molded body has a surface resistivity in the range of 10⁰ to 10⁷ ohms per square.

7. A method for producing a polyester molded body, comprising:
extruding polyester pellets and pellets containing a polyester, carbon nanotubes, and an ionic liquid such that the polyester pellets are extruded as a core, thereby forming a formed product having a surface skin layer; and removing the polyester from the skin layer of the molded body.

8. A method for producing a polyester molded body, comprising:
extruding polyester pellets and pellets containing a polyester, carbon nanotubes, and an ionic liquid such that the polyester pellets are extruded as a core, thereby forming a formed product having a surface skin layer; and removing the polyester and the ionic liquid from the skin layer of the molded body.

9. The method for producing a polyester molded body according to claim 7, wherein the polyester of the skin layer is removed by oxygen plasma treatment or alkaline water solution treatment.

10. The method for producing a polyester molded body according to claim 8, wherein the polyester and the ionic liquid of the skin layer are removed by oxygen plasma treatment or alkaline water solution treatment.
